(19) United States
(12) Patent Application Publication
(10) Pub. No.: US 2003/0053264 A1
(43) Pub. Date: Mar. 20, 2003

(54) Slider assemblies

(76) Inventors: Shixin Chen, Singapore (SG); Yi Lu, Singapore (SG)

Correspondence Address: FISH & RICHARDSON PC, 225 FRANKLIN ST, BOSTON, MA, 02110, US

(21) Appl. No.: 10/077,523

(22) Filed: Feb. 15, 2002

(30) Foreign Application Priority Data
Sep. 18, 2001 (SG) 200105702-5

(51) Int. Cl. G11B 5/56

(52) U.S. Cl. 360/294.4

(57) ABSTRACT

A slider assembly 60 for a data storage device, the assembly comprising a slider main body 110; a piezoelectric element 130 mounted on the slider main body 110; and a head 140 mounted on the piezoelectric element; wherein the slider main body can be moved and the piezoelectric element can be operated to adjust the position of the head with respect to a data storage medium.

### FIELD OF THE INVENTION

This invention relates, in one aspect, to a slider assembly. Other aspects of the invention relate to an actuator for a data storage device, a hard disk data storage device and to a computer system including such a storage device.

### BACKGROUND OF THE INVENTION

It has previously been proposed to provide a read/write head positioning system for positioning a read/write head over tracks formed in a data storage medium, such as a so-called hard disk drive (HDD) for example. This previously proposed head positioning system comprised a head mounted on the underside of a slider. An arm is connected to the slider at one end and is rotatable by means of an appropriate drive mechanism (such as a voice-coil servo motor (VCM)) to move the slider (and hence the head) in a radial direction back and forth across the surface of the disk.

Whilst devices such as these have been used for many years, it has recently been proposed to increase the areal density of HDDs (i.e. to increase the overall data storage capacity of the disk) by increasing the number of tracks provided on the HDD (referred to as increasing the track density) and/or increasing the number of bits that can be packed within a given length of track (referred to as increasing the linear density of the disk). As the track density is increased, the spacing between adjacent tracks and the size of the tracks themselves is reduced, and as a consequence head positioning systems for these high capacity disks must be capable of a higher level of head positioning accuracy than that previously required for conventional lower capacity disks.

The advent of these higher capacity disks will require the development of head positioning systems that are sufficiently accurate to permit the reading of data from, or the writing of data to, these new disks.

Generally speaking, the major sources of off-track disturbance (i.e. disturbances which cause the head to go off-track) include, for example, non-repeatable run-out from the spindle bearing, residual vibration following a track seek, windage effects of the spinning disk, vibration modes of the disk, external vibration and shock, and servo-writer errors.

The positioning accuracy of a head in a HDD, for example, is usually quoted in terms of its servo bandwidth, where the bandwidth frequency provides a measure of how well the head positioning system dampens the effects of off-track disturbances (which can be considered as the sum of sinusoidal components of various frequencies).

Typically, previously proposed head positioning systems, such as a voice coil motor, can reduce errors that fall within the bandwidth frequency of the servo but have little effect upon, and can even exacerbate, disturbances outside of that bandwidth.

In simple proportional-integral-derivative head positioning system, the most direct way to increase the servo bandwidth of the apparatus would be to increase the proportional gain. Unfortunately this is not feasible when the head is separated from the point of control input by a flexure structure (such as an E-block and suspension) because the actual head motion may lag in phase or have a different amplitude to that of the VCM. In such circumstances resonance in the flexure structure can cause the apparatus to become unstable when the proportional gain exceeds a certain value.

To improve accuracy in known head positioning systems it has been proposed to provide two-stage actuators for moving heads over the disk, with the first stage being used to coarsely adjust the position of the head over the disk and the second stage being used to finely adjust the position of the head over the disk.

Various different types of second stage (known in the art as a microactuator) have previously been proposed. For example, it has previously been proposed to use electromagnetic, electrostatic, piezoelectric or thermal elements to finely adjust the position of a head over a disk.

U.S. Pat. No. 5,943,189 describes in detail one such system where the slider of a head positioning mechanism is provided with a hinge (formed by a slit cut in the slider) and a piezoelectric element which is operable to cause the slider to bend about the hinge to change the shape of the slider, and hence vary the position of a read/write head affixed thereto.

This system, whilst going some way towards alleviating the technical problem of how to more accurately position the head, suffers from a number of drawbacks. A first of these is that it is relatively difficult to bend the hinge as the material of the slider is relatively hard and brittle. Another problem associated with this device is that it tends to provide a greater amount of head movement along the tracks of the disk (which is less useful) rather than cross-track movement in a radial direction over the disk. A further problem is that this system does not provide any real improvement to the servo bandwidth of the positioning system as a whole.

### SUMMARY OF THE INVENTION

The present invention has been conceived with the aim of alleviating at least some of the problems associated with these previously proposed devices.

To this end, one aspect of the invention provides a slider assembly for a data storage device, the assembly comprising a slider main body; a piezoelectric element mounted on the slider main body; and a head mounted on the piezoelectric element; wherein the slider main body can be moved and the piezoelectric element can be operated to adjust the position of the head with respect to a data storage medium

By locating the head on the piezoelectric element, the element is very close to the head with the result that disturbances resulting, for example, from e-block or suspension resonance can be reduced, and in some instances eliminated altogether

Another aspect of the invention relates to an actuator for a data storage device, the actuator comprising: a slider assembly as described herein; an arm connected at one end to the slider assembly; and a motor operable to rotate the arm about a pivot point to move the slider assembly back and forth over a data storage medium; wherein the motor is operable to adjust the position of the head with respect to the data storage medium by rotating the arm, and the piezoelectric element of the slider assembly is operable to adjust the position of the head with respect to the data storage medium.

By locating the head on the piezoelectric element, the element is very close to the head with the result that disturbances resulting, for example, from e-block or suspension resonance can be reduced, and in some instances eliminated altogether.

In addition, by providing a piezoelectric element that acts directly on the head the amount of material to be moved by the piezoelectric element (and hence the stress on the element) can significantly be reduced.

Another aspect of the invention relates to a hard disk data storage device comprising: a platter carrying a magnetic data storage medium; an actuator as described herein; a first control circuit operable to control the motor to adjust the position of the head with respect to the data storage medium; a second control circuit operable to control the piezoelectric element to adjust the position of the head with respect to the data storage medium; and an input/output interface for input of signals to and output of signals from the hard disk data storage device.

A yet farther aspect of the invention relates to a computer system comprising at least one hard disk data storage device as described herein.

Another aspect of the invention relates to a method of manufacturing a slider assembly, the method comprising the steps of: forming a slider main body and a piezoelectric element; attaching the element to the slider main body; and forming a head on the element.

Yet another aspect of the invention relates to a method of manufacturing a slider assembly, the method comprising the steps of: forming a slider main body, a piezoelectric element and a head; attaching the element to the slider main body, and attaching the head to the element.

Other features of these aspects of the invention are set out in the dependent claims.

### BRIEF DESCRIPTION OF THE DRAWINGS

A number of preferred embodiments of the invention will now be described, by way of example only, with reference to the accompanying drawings, in which:

FIG. 1 is a perspective view of a hard disk drive embodying the invention;

FIG. 2 is a side view of a portion of the drive of FIG. 1;

FIG. 3 is a schematic view of the underside of a slider assembly as shown in FIGS. 1 and 2;

FIGS. 4A and 4B provide a top perspective view and an end view, respectively, of a slider;

FIGS. 5A, 5B and 5C show, respectively, a rear elevation, a rear perspective view and a side view of a piezoelectric element;

FIGS. 6A, 6B and 6C show, respectively, a rear elevation, a rear perspective view and a side view of an alternative design of piezoelectric element;

FIGS. 7A, 7B and 7C show, respectively, a rear elevation, a rear perspective view and a side view of another alternative design of piezoelectric element;

FIGS. 8A and 8B provide a top perspective view and an end view, respectively, of a slider on which the piezoelectric element of FIGS. 7A, 7B and 7C can be mounted;

FIG. 9 illustrates schematically a number of electrical interconnects or a piezoelectric element; and

FIG. 10 is a schematic illustration of a computer system.

### DETAILED DESCRIPTION OF THE PREFERRED EMBODIMENTS

Various embodiments of the invention will be described hereafter with particular reference (for illustration only) to a hard disk drive (HDD) for a computer system. However, it will be apparent to persons skilled in the art that the teachings of the present invention may be applied to a variety of different data reading and/or writing apparatus, or indeed in any application where it is desired to accurately position a read and/or write head over the surface of a data storage medium. As a consequence, the following description should not be read as limiting the scope of the invention to any one particular use, and it should be noted that the teachings of the invention may be employed in devices other than hard disk drives (HDD).

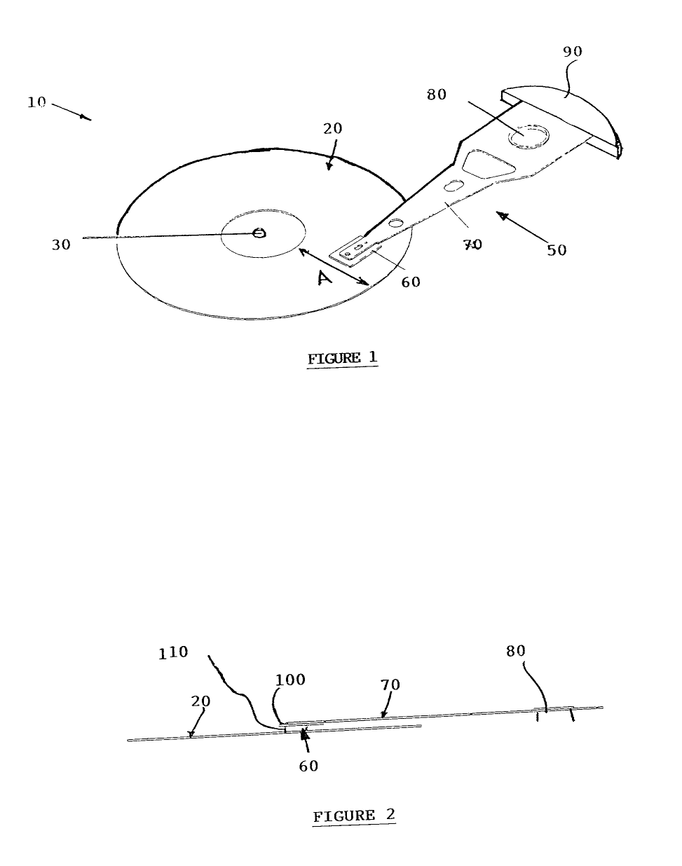

As mentioned above, FIG. 1 is a schematic view of a hard disk drive 10 embodying the teachings of the invention. The hard disk drive 10 comprises, in common with other known hard disks, a platter 20 (typically of aluminium or aluminium alloy) that has, for example, a thin film magnetic data-recording surface formed thereon. After applying the magnetic surface, each platter is usually covered with a thin, protective, layer made of carbon followed by a super-thin lubricating layer. These materials are used to protect the disk from damage caused by accidental contact from the heads or other foreign matter that might get into the drive. The platter 20 is mounted on a spindle 30 and is rotatable by a spindle motor (not shown).

Associated with the platter is an actuator 50 comprising a slider assembly 60, the actuator being operable to adjust the position of the slider assembly 60 over the surface of the platter 20. Although only a single platter and associated actuator is shown, it will be apparent to persons skilled in the art that the HDD will typically comprise (as is common in the art) a stack of platters and associated actuators.

The actuator 50 comprises an arm 70 that carries the slider assembly 60 on one end. The arm 70 is rotatably mounted on a pivot pin 80, and the end of the arm furthest from the platter is associated with a drive mechanism (indicated generally by reference numeral 90) that is operable to rotate the arm about the pivot pin.

In the preferred arrangement, the drive mechanism comprises a voicecoil servo motor that is operable to move the arm (and hence the slider assembly) back and forth in a generally radial direction over the surface of the platter 20. A closed-loop feedback system (not shown) is operable to dynamically position the slider assembly over the platter. A coil (not visible) is provided on the end of the arm furthest from the platter, and the coil locates within a housing that contains a permanent magnet. When current is fed to the coil, an electromagnetic field is generated that causes the arm to rotate about the pivot pin 80 in one direction or the other based on attraction or repulsion relative to the permanent magnet. As an alternative to a voice coil motor, the actuator could comprise a stepper motor or any other suitable motor. The drive mechanism 90 provides a relatively coarse adjustment of the position of the slider assembly 60 over the platter 20, and additional means (which will later be described) provide a relatively fine adjustment of the position of a head (mounted on the slider assembly 60) over the surface of the platter.

FIG. 2 is a side view of a portion of the drive of FIG. 1 showing the platter 20, the slider assembly 60, the arm 70, and the pivot pin 80. The slider assembly 60 comprises a flexure 100 and a slider 110 which flies above the surface of the platter 20 as the platter is rotated by the spindle motor (not shown). The flexure need not necessarily be provided as the slider could be mounted directly on the end of the arm 70, although the provision of a flexure is preferred since it functions to reduce shock and vibration transmission through the arm to the head and vice versa.

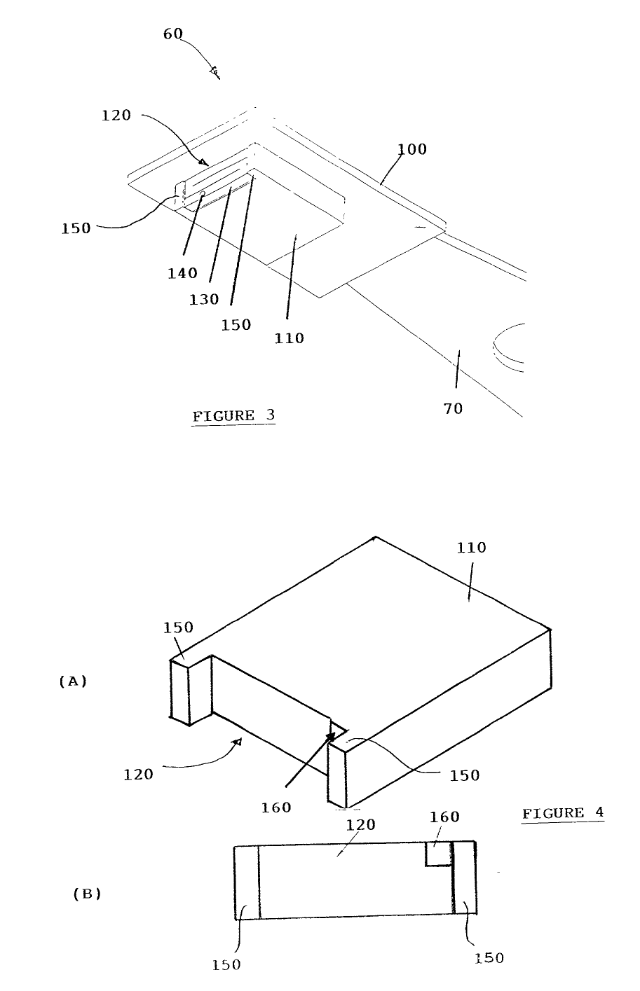

FIG. 3 is a schematic view of the underside (i.e. the side facing the platter) of the slider assembly 60 shown in FIGS. 1 and 2. As shown, the slider 110 is connected to the flexure 100, and the flexure 100 is connected to the arm 70.

As shown in FIG. 3, the end of the slider 110 furthest from the arm rotating drive mechanism 90 (which end will be referred to hereinafter as the trailing end) is provided with a notch 120, which can be cut out from the slider or formed integrally with the slider. A piezoelectric element 130 is mounted on the slider 100 within the notch, and a head 140 is provided on the piezoelectric element 130. Advantageously, end portions 150 of the notch 140 extend beyond the piezoelectric element 130 in both horizontal and vertical dimensions to recess the element 130 in the slider so that it and the head are protected from damage in the event that the slider 110 should crash against the surface of the platter 20 during operation of the HDD.

Although it is preferred that the piezoelectric element 130 is mounted in a notch 140 cut in the slider it is not essential for the notch to be provided, and as an alternative the element 130 could simply be mounted on the trailing end of the slider.

The head 140, in a preferred embodiment, is operable to write data to and read data from the magnetic data-recording surface on the platter 20. However, if the teachings of the invention are to be employed in devices other than HDDs, then the head may only be capable of reading data from the platter or writing data to the platter as required. In any event, it is preferred that the head is provided on a portion of the element 130 which will be closest to the data storage medium, i.e. in this case the platter 20.

The head of the preferred embodiment may comprise a conventional single transducer capable of reading and writing data to the platter (such as a ferrite, metal-in-gap or thin film transducer) or alternatively it may comprise a pair of transducers, one of which is a transducer for reading data from the platter (such as a magnetoresistive transducer for example) and the other of which is a transducer for writing data to the platter (such as one of the aforementioned conventional transducers). Other configurations will be apparent to persons skilled in the art, and all of these configurations will be referred to generally herein as a head.

The piezoelectric element 130 is connected (although not shown in FIG. 3) to an electrical supply. In the preferred embodiment the element 130 has a multi-layer structure fabricated for example by film printing or jet printing technology. The element is shaped, and the electrical connections are placed, so that the application of a potential difference to the element 130 causes the length of the element to change and the transducer to move in a radial direction (indicated by arrow A in FIG. 1) back and forth over the surface of the platter 20. By varying the potential difference applied, the radial position of the transducer with respect to the platter can be adjusted; and as the voltage applied to the element 130 can be changed in small increments, so the radial position of the transducer can also be varied in small increments. In this embodiment (as shown), the piezoelectric element is generally “S” shaped, i.e. shaped like one cycle of a square wave or a zig-zag.

It will be apparent from the above that the piezoelectric element 130 provides a means for relatively fine adjustment of the position of the transducer with respect to the platter. By utilising a conventional drive mechanism 90 for coarse adjustment of the head position, and the piezoelectric element 130 as a mechanism for finely adjusting the position of the head, the position of the head with respect to the platter can more accurately be adjusted than has otherwise been possible with prior art systems. In addition, by locating the head on the piezoelectric element the servo bandwidth of the head positioning apparatus as a whole can be improved.

Typically, in previously proposed single stage actuation systems it is only possible to achieve a low servo bandwidth in the range of 700 Hz to 1.5 kHz. By implementing the teachings of the present invention it is possible to provide a servo bandwidth that is higher than that previously possible, typically above 5 kHz.

To enable the piezoelectric element 130 to expand and contract (as the applied voltage is varied) without hindrance from the slider 110, the element is attached to the slider, in the preferred embodiment, at only one point.

FIGS. 4A and 4B provide a top perspective view and an end view, respectively, of the slider 110 with the piezoelectric element 130 removed to illustrate the placement of a mounting pad 160 in the notch provided in the trailing end of the slider. As shown, the mounting pad of this embodiment is formed in the top right hand comer of the notch. The mounting pad may be formed with the slider, or alternatively formed separately and then affixed to the slider.

As shown in FIGS. 5A, 5B and 5C one end of the piezoelectric element 130 is formed with a projection 170, and the projection 170 is located so that it can be affixed to the mounting pad 160 on the slider 110 (see FIGS. 4A and 4B) to mount the element 130 on the slider 110. Because of this arrangement, only one end of the piezoelectric element is fixed to the slider with the remainder of the element 130 being suspended in free space so that the element is free to expand or contract without hindrance from the body of the slider. As an alternative to this arrangement, the element could be mounted directly on the slider main body without any intervening pad.

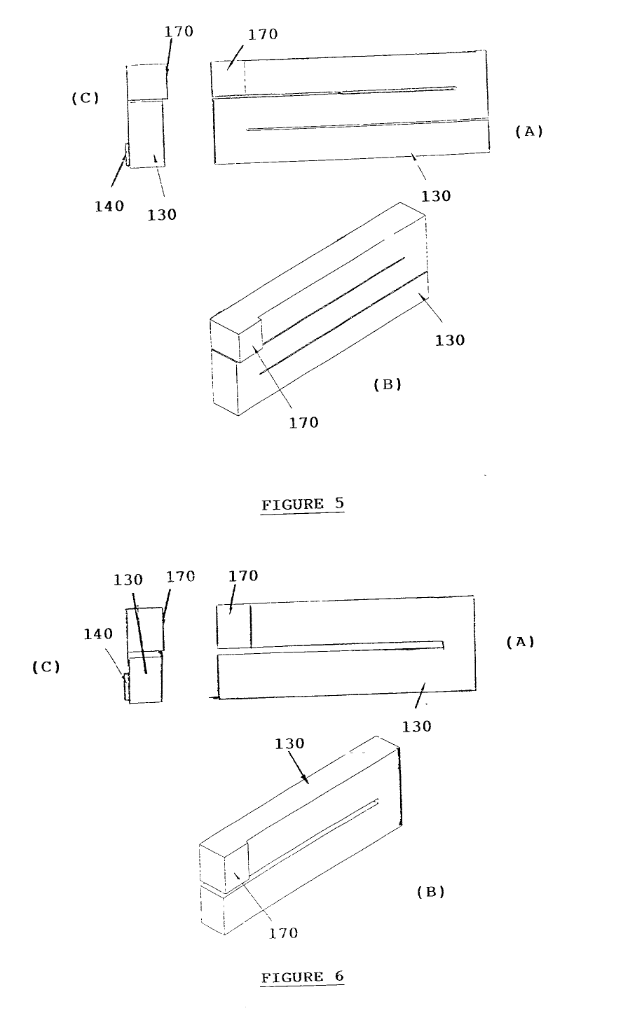

FIGS. 6A, 6B and 6C show an alternative design of piezoelectric element 130 for mounting to the slider shown in FIGS. 4A and 4B. As shown, the element 130 of this embodiment is generally “C” shaped.

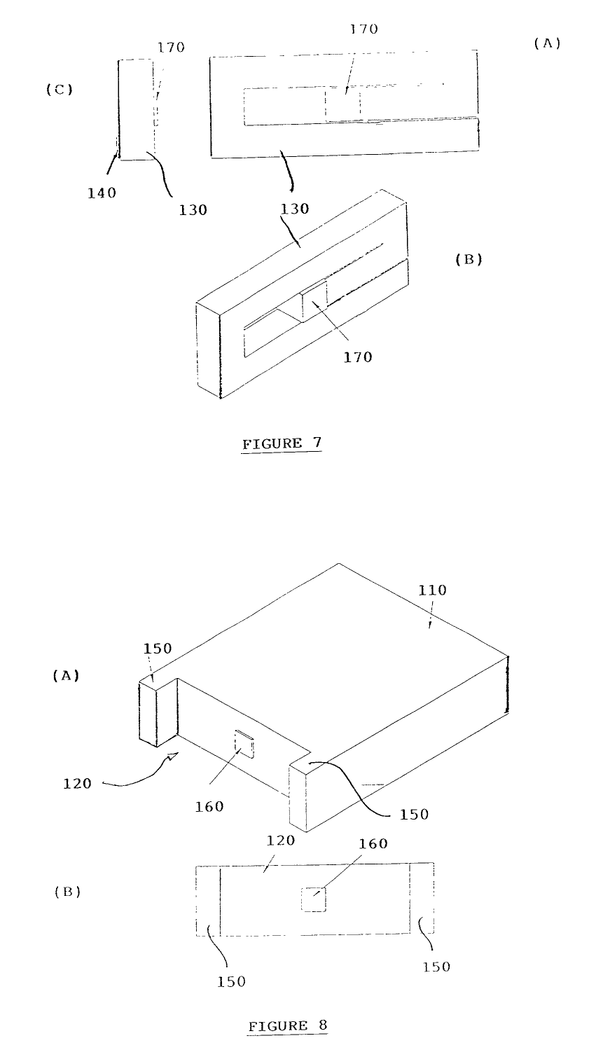

FIGS. 7A, 7B and 7C show another alternative design of piezoelectric element 130; and FIGS. 8A and 8B provide a top perspective view and an end view, respectively, of a slider on which the piezoelectric element of FIGS. 7A, 7B and 7C can be mounted.

As shown in FIGS. 8A and 8B, in this embodiment the mounting pad 160 is provided roughly in the centre of the notch formed in the trailing end of the slider 110. The piezoelectric element shown in FIGS. 7A, 7B and 7C is shaped like a portion of a spiral, and the end of the element in the centre of the spiral is provided with the projection 170 which is affixed to the pad 160 to mount the element on the slider 110.

Whilst three differently shaped piezoelectric elements have been described above, it will be appreciated by persons skilled in the art that a variety of alternative designs may be adopted if desired with the location of the mounting pad on the slider being varied as required for proper mounting of the element.

The element shown in FIGS. 6A, 6B and 6C—in comparison with that shown in FIGS. 5A, 5B and 5C—is capable of moving the head a smaller distance than the element of FIG. 5, but with a greater accuracy. The element of FIG. 5 is capable of moving the head a greater distance than the element of FIG. 6, but with a lower accuracy. In other words, the element of FIG. 6 has a smaller stroke with a higher resonant frequency, and hence the positioning operation will have a higher bandwidth. Similarly, the element of FIG. 5 has a greater stroke with a lower resonant frequency, and hence a lower bandwidth. In any event, the bandwidth that is achievable with the teachings of the invention is significantly larger than that achievable with previously proposed systems.

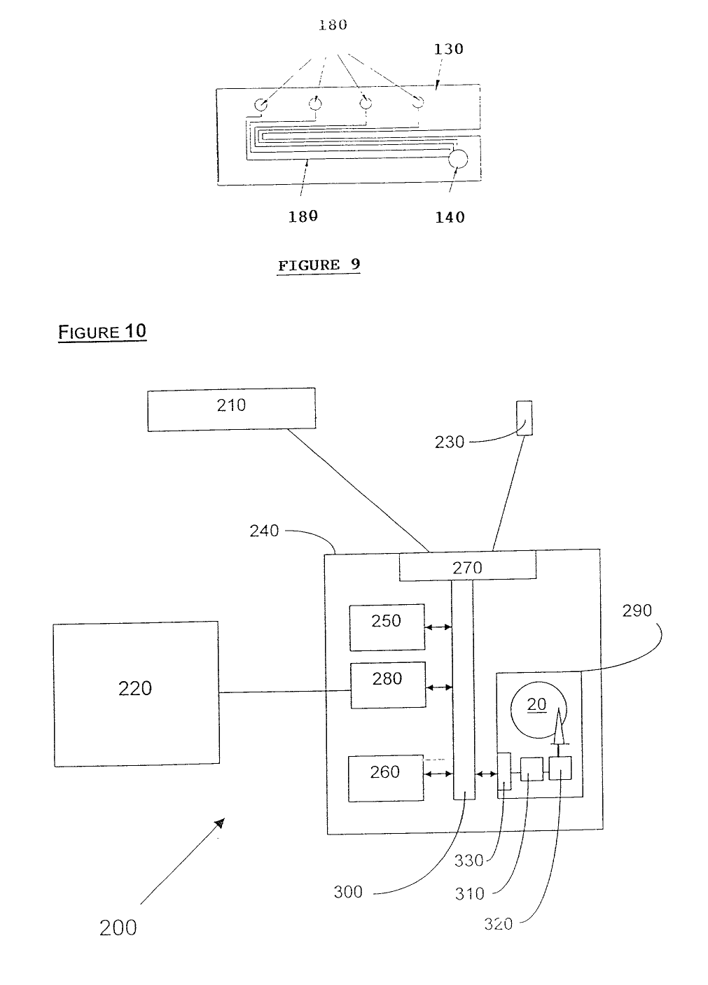

The head mentioned above can be separately manufactured from the piezoelectric element, and subsequently attached thereto. Alternatively, in the preferred embodiment, the head can formed directly on the piezoelectric element. FIG. 9 illustrates schematically a number of electrical interconnects 180 which are provided to enable the head to be connected to other components of the HDD. Advantageously, the interconnects can be formed directly on the element (possibly at the same time as the head) to obviate the conventional practise of bonding external interconnects to the head.

As mentioned above, the slider assembly described herein can be used in a HDD in a computer system. FIG. 10 illustrates schematically various components of such a system.

As shown, the computer system 200 comprises a keyboard 210, a monitor 220, a mouse 230 and a main housing 240 within which other components of the system are provided.

The main housing contains a central processing unit 250 (which typically comprises a processor mounted on a motherboard together with other electronic components such as cache memory), random access memory (RAM) 260, an input/output interface 270, a video controller 280 for providing images on the monitor 220 and a hard disk data storage device 290. Other additional components may also be provided. All of the components within the housing are connected to a data bus 300 for data transfer between the components, and between the components inside the housing and the outside world.

The hard disk data storage device comprises at least one platter 20 and associated actuator and slider assembly as described in detail above. The HDD also includes first control circuitry 310 for controlling coarse position adjustment of the slider assembly, and second control circuitry 320 for controlling fine position adjustment of the transducer that forms part of the slider assembly. An interface 330 is provided to permit data to be transferred between the platter of the HDD and the other components of the system.

By adopting the principles of the present invention, the computer system 200 is provided with a HDD that can have a greater areal density than conventional drives, and hence can either be smaller than conventional drives or store more information in the same footprint as conventional drives.

Although various preferred embodiments of the invention have been described above, it should be noted that these embodiments have been described by way of example only. Accordingly, it should be noted that modifications may be made to the particular embodiments described without departing from the scope of the invention as defined in the accompanying claims.

For example, whilst the description provided above relates particularly to HDD it will be appreciated by persons skilled in the art that the teachings of the invention may be utilised in any application where it is desired to control the position of a head over the surface of a data storage medium.

It will also be apparent that the teachings of the invention may be employed in circumstances where it is desired to adjust the gap between the head and the data storage medium, either in addition to or in place of adjusting the horizontal position of the head with respect to the surface of the data storage medium.

It will also be apparent that whilst the preferred embodiments of the invention employ a piezoelectric element, it may be possible to use other types of element (eg. electromagnetic or thermal elements) to achieve a similar effect. Accordingly, it should be noted that the scope of the invention is not limited to piezoelectic elements

1. A slider assembly for a data storage device, the assembly comprising a slider main body; a piezoelectric element mounted on the slider main body; and a head mounted on the piezoelectric element; wherein the slider main body can be moved and the piezoelectric element can be operated to adjust the position of the head with respect to a data storage medium.

2. A slider assembly according to claim 1, wherein the piezoelectric element is operable to move the head in a direction generally parallel to a data bearing surface of the data storage medium.

3. A slider assembly according to any preceding claim, wherein the piezoelectric element is mounted on a trailing end of the slider main body.

4. A slider assembly according to any preceding claim, wherein the piezoelectric element is connected at one end to the slider main body, the remainder of the element being suspended from the slider main body.

5. A slider assembly according to claim 4, wherein the head is mounted towards the end of the element furthest from said one end connected to said slider main body.

6. A slider assembly according to claim 4, wherein the slider main body is provided with a mounting pad, said one end of said piezoelectric element being provided with a projection affixable to said mounting pad.

7. A slider assembly according to claim 6, wherein the mounting pad is formed integrally with said slider main body.

8. A slider assembly according to claim 6, wherein the mounting pad is formed separately from said slider main body and subsequently affixed thereto.

9. A slider assembly according to any preceding claim, wherein the piezoelectric element is generally “S” shaped.

10. A slider assembly according to any of claims 1 to 8, wherein the piezoelectric element is generally “C” shaped.

11. A slider assembly according to any of claims 1 to 8, wherein the piezoelectric element is generally spiral.

12. A slider assembly according to any preceding claim, wherein the slider main body is provided with a notch, said element being located within said notch.

13. A slider assembly according to claim 12, wherein the element is at least partly recessed within said notch.

14. A slider assembly according to claim 12 or 13, wherein the slider main body surrounding the notch extends beyond the element in a direction generally parallel to a data bearing surface of the data storage medium and in a direction generally perpendicular to the data bearing surface of the data storage medium.

15. A slider assembly according to any preceding claim, wherein the head is a read/write head operable to read data from the data storage medium and write data to the data storage medium, said head comprising a read/write transducer.

16. A slider assembly according to any of claims 1 to 14, wherein the head is a read/write head operable to read data from the data storage medium and write data to the data storage medium, said head comprising a read transducer and a write transducer.

17. A slider assembly according to any preceding claim, wherein the element comprises integrated interconnects for carrying signals to and/or from the head as required.

18. A slider assembly according to any of claims 1 to 14, wherein the head comprises either a read head operable to read data from the data storage medium or a write head operable to write data to the data storage medium,

19. An actuator for a data storage device, the actuator comprising:
a slider assembly according to any preceding claim;
an arm connected at one end to the slider assembly; and
a motor operable to rotate the arm about a pivot point to move the slider assembly back and forth over a data storage medium;
wherein the motor is operable to adjust the position of the head with respect to the data storage medium by rotating the arm, and the piezoelectric element of the slider assembly is operable to adjust the position of the head with respect to the data storage medium.

20. An actuator according to claim 19, wherein the motor and the element are operable independently of one another to vary the position of the head with respect to the data storage medium.

21. An actuator according to claim 19 or 20, wherein the motor comprises a voice coil motor.

22. An actuator according to any of claims 19 to 21, wherein the servo bandwidth of the actuator is greater than 1.5 kHz.

23. An actuator according to any of claims 19 to 22, wherein the servo bandwidth of the actuator is greater than or equal to 5 kHz.

24. An actuator according to any of claims 19 to 23 where the arm is connected to the slider assembly by way of a flexure which functions to reduce shock and/or vibration transmission through the arm to the head and vice versa.

25. A hard disk data storage device comprising:
a platter carrying a magnetic data storage medium;
an actuator according to any of claims 19 to 23 when dependent upon any of claims 1 to 17;
a first control circuit operable to control the motor;
a second control circuit operable to control the piezoelectric element; and
an inputloutput interface for input of signals to and output of signals from the hard disk data storage device.

26. A computer system comprising at least one hard disk data storage device according to claim 25.

27. A method of manufacturing a slider assembly, the method comprising the steps of: forming a slider main body and a piezoelectric element; attaching the element to the slider main body; and forming a head on the element.

28. A method of manufacturing a slider assembly, the method comprising the steps of: forming a slider main body, a piezoelectric element and a head; attaching the element to the slider main body, and attaching the head to the element.

29. A method according to claim 27 or 28, comprising the further step of forming interconnects on said element to carry signals to and/or from said head.

30. A slider assembly comprising:
a slider main body having a trailing end and a leading end, a notch being formed in said trailing end;
a piezoelectric element having a first end and a second end and being formed so as to be generally “S” shaped or generally “C” shaped or generally spiral, said piezoelectric element being connected proximate said first end to a mounting pad provided on the slider main body so that the remainder of said element is freely suspended from said slider main body; and
a head mounted proximate said second end of said piezoelectric element;
wherein the piezoelectric element is mounted on the slider main body so as to be wholly recessed within the notch.
